(19) United States
(12) Patent Application Publication
(10) Pub. No.: US 2018/0089344 A1
(43) Pub. Date: Mar. 29, 2018

(54) ADAPTIVE METHODOLOGY FRAMEWORK SYSTEM AND METHOD THEREOF

(71) Applicant: Zensar Technologies Ltd., Pune (IN)

(72) Inventor: Girish Kumar Purohit, Pune (IN)

(21) Appl. No.: 15/716,723

(22) Filed: Sep. 27, 2017

Related U.S. Application Data
(60) Provisional application No. 62/441,959, filed on Jan. 3, 2017.

(30) Foreign Application Priority Data
Sep. 28, 2016 (IN) 201621033089

(51) Int. Cl. G06F 17/50; G06N 99/00; G06F 17/30; G06F 17/18

(52) U.S. Cl. CPC G06F 17/505; G06N 99/005; G06F 17/18; G06F 17/30471; G06F 17/30522

(57) ABSTRACT

The present disclosure relates to an adaptive methodology framework system and method thereof. The system includes a program repository to store a program package and a program data, a trend repository to store current trends, a program evaluator to generate evaluated program data, a diagnosis module to identify current issues present in the program package, a prediction module to predict future issues in the program package, a solution recommendation module to recommend a first set of solutions for the current issues and the future issues and a trend recommendation module to recommend a second set of solutions based on the current trends.

### FIELD

The present disclosure relates to the field of an adaptive methodology framework.

### Definition

The expression ‘product’ used in the context of this disclosure refers to, but is not limited to, a program package that requires continuous support and maintenance services for preventing itself from becoming uneconomical and technologically redundant.

The expression ‘smart use case’ used in the context of this disclosure refers to, but is not limited to, a technique that describes a system's behavior in which the system responds to a request that originated by another system.

The expression ‘users’ used in the context of this disclosure refers to, but is not limited to, customers who uses existing products.

The expression ‘robotic process automation (RPA)’ used in the context of this disclosure refers to, but is not limited to, a process that allows users to configure a program package, or a “robot” to capture and interpret existing applications for processing a transaction, manipulating data, triggering responses and communicating with other digital systems.

The expression ‘cascading’ used in the context of this disclosure refers to, but is not limited to, create and execute complex data processing workflows.

This definition is in addition to those expressed in art.

### BACKGROUND

Today, organizations are competing in an era of economic uncertainty and frequent technological advancements and changes in their products. Since the world is continually changing, organizational learning is necessary for the organizations to protect their products from becoming uneconomical and technologically redundant. Further, customers also expect the organizations to adapt quickly to the technological advancements and the economic uncertainty, which leads to unrealistic global pressure. Thus, the organizations seek to continuously evaluate, upgrade and maintain the existing and conventional products such as computer implemented systems, to remain competitive and maximize their overall profit. Amidst global pressure, the organizations have been able to upgrade, maintain and support the conventional computer implemented systems via reactive approach by developing a response development tool sub-system that typically comprises users who solve problems after they have occurred.

Further, the process of evolution, upgrading, supporting and maintaining the conventional computer implemented systems is typically empirical and unstructured. The decisions for solving any problem in the conventional systems are taken empirically and not in a sequential and organized manner. Also the decisions are completely taken by humans and therefore, a sense of dependency in decision making exists. The post-development phase including, but not limited to, the upgradation and maintenance of the system requires maximum effort, and costs between 60-80% of the total expense bore by the organization.

Conventionally, most of the organizations follow the reactive approach, i.e., the response development tool sub-system model where problems are fixed after they occur and after they are notified by the users or other agencies hired to do so. However, the response development tool sub-system model can be hazardous for the organizations when any major issue arises or reoccurrence of normal issues, as occurrence of any issue is unpredictable and unpreventable which can hamper the planning and can lead to high operations cost. Additionally, customers are dissatisfied with the operations or services as deadlines are not met, and proper analytics is not done to improve the stability of the system in case of the response development tool sub-system model.

Hence, there is a need for developing an adaptive methodology framework system to alleviate the abovementioned drawbacks of upgrading, supporting, and maintaining conventional and existing support systems. Also, there is a need for the adaptive methodology framework system and method thereof, which has a structured and standardized framework, thereby reducing maintenance cost, and increasing customer satisfaction.

### Objects

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide an adaptive methodology framework system that performs in an optimal manner from cost and time perspective.

Another object of the present disclosure is to provide an adaptive methodology framework system that is capable of partially or completely automating the operational process, which reduces human effort.

Still another object of the present disclosure is to provide an adaptive methodology framework system that is industry agnostic.

Yet another object of the present disclosure is to provide an adaptive methodology framework system that satisfies scalability and stability requirement of the conventional support systems.

One another object of the present disclosure is to provide an adaptive methodology framework system that recommends or executes solutions which are less vulnerable to human error.

Another object of the present disclosure is to provide an adaptive methodology framework system that improves predictability of occurrence of an issue.

Yet another object of the present disclosure is to provide an organization with a methodology to identify the self-healing and self-solutioning use cases that can be implemented in an existing system as patches or supporting modules.

Other objects and advantages of the present disclosure will be more apparent from the following description, which is not intended to limit the scope of the present disclosure.

### SUMMARY

The present disclosure envisages an adaptive methodology framework system. The system includes a memory, a processor, a program repository, a trend repository, a program evaluator, a diagnosis module, a prediction module, a solution recommendation module, and a trend recommendation module. The memory is configured to store historical data and a set of rules including diagnosis rules, prediction rules, and solution recommendation rules. The processor is configured to receive the set of rules from the memory and is further configured to generate system processing commands. The program repository is configured to store a program package and a program data related to the program package. The trend repository is configured to store current trends. The program evaluator is configured to evaluate the program package and the program data to generate evaluated program data. The diagnosis module is configured to analyze the evaluated program data to identify current issues present in the program package based on the diagnosis rules. The prediction module is configured to predict future issues in the program package based on the evaluated data, the current issues, the historical data and the prediction rules. The solution recommendation module is configured to recommend a first set of solutions for the current issues and the future issues based on the historical data and the solution recommendation rules. The trend recommendation module configured to cooperate with the program evaluator and the trend repository to receive the evaluated program data and the current trends, respectively, and further configured to recommend a second set of solutions based on the current trends.

In an embodiment, the diagnosis module includes a first analyzer. The first analyzer is configured to analyze the evaluated program data.

In an embodiment, the prediction module includes a second analyzer. The second analyzer is configured to analyze the evaluated data, the current issues, and the historical data.

In an embodiment, the program repository includes a requirement module. The requirement module is configured to receive additional requirements from a user.

In an embodiment, the trend repository includes an updater module. The updater module is configured to update the trend repository.

In an embodiment, the trend recommendation module is configured to recommend solutions, using at least one technique selected from the group consisting of smart use cases, robotic process automation (RPA), partial automation, full automation, and self-service tools.

The present disclosure also envisages a method for providing an adaptive methodology framework comprising the following steps:
storing, in a memory, historical data and a set of rules including diagnosis rules, prediction rules, and solution recommendation rules;
receiving, by a processor, the set of rules and generating system processing commands;
storing, in a program repository, a program package and a program data related to the program package;
storing, in a trend repository, current trends;
evaluating, by a program evaluator (110), the program package and the program data to generate evaluated program data;
analyzing, by a diagnosis module, the evaluated program data to identify current issues present in the program package based on the diagnosis rules;
predicting, by a prediction module, future issues in the program package based on the evaluated data, the current issues, the historical data and the prediction rules;
recommending, by a solution recommendation module, a first set of solutions for the current issues and the future issues based on the historical data and the solution recommendation rules; and
receiving, by a trend recommendation module, the evaluated program data and the current trends, and recommending a second set of solutions based on the current trends.

### BRIEF DESCRIPTION OF ACCOMPANYING DRAWING

An adaptive methodology framework system and method thereof of the present disclosure will now be described with the help of the accompanying drawing, in which:

FIG. 1 illustrates a schematic block diagram of an adaptive methodology framework system, according to an embodiment of the present disclosure.

FIGS. 2A and 2B illustrate a flow diagram showing steps performed by the adaptive methodology framework system of FIG. 1, in accordance with an embodiment of the present disclosure.

### LIST OF REFERENCE NUMERALS

| | |
|---|---|
| 100 | System |
| 102 | Memory |
| 104 | Processor |
| 106 | Program Repository |
| 106a | Requirement Module |
| 108 | Trend Repository |
| 108a | Updater Module |
| 110 | Program Evaluator |
| 112 | Diagnosis Module |
| 112a | First Analyzer |
| 114 | Prediction Module |
| 114a | Second Analyzer |
| 116 | Solution Recommendation Module |
| 118 | Trend Recommendation Module |

### DETAILED DESCRIPTION

The present disclosure relates to an adaptive methodology framework system and method thereof, which successfully manages, upgrades, and maintains the existing and conventional response development tool sub-system framework models that, operates in a reactive manner. The adaptive methodology framework system and method thereof, in accordance with an embodiment of the present disclosure will now be described with reference to the embodiments, which do not limit the scope and ambit of the disclosure.

The term “adaptive” refers to a mechanism, methodology or service through which a system develops a capacity for or tendency toward adaptation. Unlike a traditional reactive approach to issue resolution, the present disclosure gives paramount importance to the maintainability of the computer based system it serves; this in turn will bring about improvements such as operations cost savings, reduced mean time to repair, improved cycle time of a process, typically a manufacturing process, superior customer experience and faster adoption of change. This continually analyzes the changes and impact of the changes to the end to end system. This analysis of the existing system and changes will throw up the parameters and milestones that are most important to the system and an understanding of how they impact the overall process, typically a manufacturing process. The adaptive approach forces the teams owing the computer based system to collaborate and seek solutions to the problems that occur during operation or implementation or execution of the process.

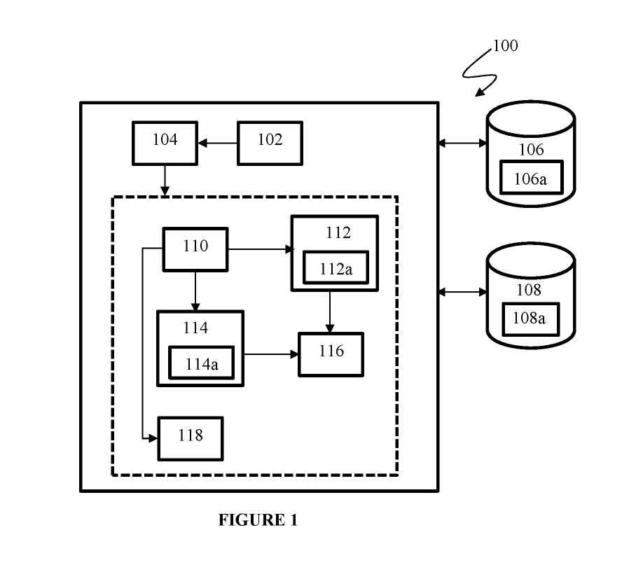

The adaptive methodology framework system of the present disclosure is described with reference to FIG. 1 of the accompanying drawing.

FIG. 1 illustrates a block diagram of an adaptive methodology framework system (hereinafter referred as “system') (100), in accordance with an embodiment of the present disclosure.

The system (100) includes a memory (102), a processor (104), a program repository (106), a trend repository (108), a program evaluator (110), a diagnosis module (112), a prediction module (114), a solution recommendation module (116), and a trend recommendation module (118).

The memory (102) is configured to store a set of pre-determined rules. The memory (102) may include any computer-readable medium known in the art including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes, and/or a cloud based storage (cloud storage). In an embodiment, the memory (102) is configured to store historical data and predetermined rules related diagnosing the issues, predicting the issues, and solution recommendation. In an embodiment, the memory (102) is further configured to store the rules related to prioritizing the issues program data, monitoring data, and the like.

In one embodiment, the diagnosis rules include, but are not limited to, the rules related to debugging, monitoring, and scanning of the program data. The predicting rules include, but are not limited to, the rules related to machine learning. The solution recommendation rules include, but are not limited to, the rules related to the solution for characterize issues, such as critical incident problem, change/release problem, long term problem, and the like.

The processor (104) is configured to cooperate with the memory (102) to receive and process the pre-determined rules to obtain a set of system operating commands. The processor (104) may be implemented as one or more microprocessors, microcomputers, microcontrollers, digital signal processors, central processing units, state machines, logic circuitries, and/or any devices that manipulate signals based on operational instructions. Among other capabilities, the processor (104) is configured to fetch and execute the set of predetermined rules stored in the memory (102) to control modules of the system (100).

The program repository (106) is configured to store the program package and a program data related to the program package. The program data may include documents, guidelines and best practices related to all the issues that may occur during an operation of the product, and the like. The program repository (106) includes a requirement module (106a), which is configured to receive additional requirements from the user. In an embodiment, the program repository (106) also stores logical milestones of processes, and parameters which impact the program package.

The trend repository (108) is configured to store current trends. The current trends may be based on learning phase, and practice and guidelines set by the user. The trend repository (108) includes an updater module (108a), which is configured to update the trend repository (108). The updater module (108a) continually updated the trend repository (108) based on the current market trends.

The program evaluator (110) is configured to cooperate with the program repository (106) and the processor (104), and is further configured to evaluate the program package and the program data to generate evaluated program data.

The diagnosis module (112) is configured to cooperate with the program evaluator (110) to receive the evaluated data, and is further configured to analyze the evaluated program data to identify current issues present in the program package based on the diagnosis rules. In an embodiment, the diagnosis module (112) is configured to periodically monitor the program data on a proactive basis, and identify issues which are going to affect the system in a critical manner. The diagnosis module (112) includes a first analyzer (112a), which is configured to analyze the evaluated data. In an embodiment, the diagnosing module (112) performs health monitoring, check application stability, check performance, and P1/P2 management.

In an embodiment, the diagnosing module (112) identifies the repetitive issues and finding root cause for the repetitive issues. The diagnosing module (112) maintains and tracks metrics of the past issues and their resolutions. If an issue is re-occurring, then it needs to be analyzed for a permanent solution. In an embodiment, the metrics are created using use cases which are based on past trends.

A pseudo-code depicting the functionality of the diagnosis module (112), in accordance with an embodiment of the present disclosure, is as follows:

Suppose, total number of tasks N performed their functions in an event M. Each task T is to be scheduled in M and each of the same tasks T performs their respective functions in M. The diagnosis module (112) periodically monitors the functions of T on a proactive basis and identifies problems in a critical manner.

```
Periodic_Scheduler( )
      {
            T = Schedule_Table [S];
            S=S−1;
            S = S mod N;
```

Create a Schedule Table for M:

```
print_entries(100)
{
  for (int i = 0; i < size(100); i++)
  {
    if (i mod 100 == 0 AND i > 0)
      print NEWENTRY;
    else
    print n[i] + “empty”;
  }
}
```

When T invokes a stack operation on an instance, the operation gets dispatched to the corresponding operation in the Schedule Table. The table is initialized by the function of T corresponds to N.
stack *s1=stack_array_create ( );
stack *s2=stack_list create( )
stack_push (T1, 1);
stack_push (T2, 1);
Here, for T1, dispatches to stack_array_push ( ) and for T2, dispatches to stack_list_push ( ).
Dispatch T;

schedule_irregular_instance_tasks ( );

schedule_aperiodic_tasks ( );
Idle ( );
Identify the problems of M including T with the help of the created Schedule Table.
   Input the utilization of each task T in M. For example, 1 is for full utilization and 0 for no utilization.
   Input the turnout values, where the number of tasks completed in per unit time. For example, T11 takes 5 minutes to complete the task.
   Input time, which is required for completion of task T.
   Input the time in which how much time N spend in a queue their turn to get in M.
   Input the average number of N sitting in the queue waiting their turn to get in M. For example, 10 minutes averages by uptime and who takes it.
   Input Response time, where the time taken in the schedule M from the issuance of a command to commence of a response to that command.
Set the priority of the problems:

Highly critical or speedy fix or short-term fix; and

Long term fix to the critical incident and recurring problems.

The prediction module (114) is configured to cooperate with the program evaluator (110) and the memory (102) to receive the evaluated data and the historical data and the prediction rules, and is further configured to predict future issues in the program package based on the evaluated data, the current issues, the historical data and the prediction rules stored in the memory (102). In an embodiment, the prediction module (114) is configured to recover the program package, if any major issue is predicted. In another embodiment, the prediction module (114) takes users interaction and learning into account for analyzing and predicting the future issues, thereby improving the efficiency and productivity of the system (100). The learning may be based on the in depth analysis of an end to end functionality of the program package.

The prediction module (114) includes a second analyzer (114a), which is configured to analyze the evaluated data, the current issues, and the historical data to predict the future issues in the program package, received from the program evaluator (110) and the memory (102). The second analyzer (114a) is configured to analyze and predict start to end point processes causing bottleneck, inbound and outbound processes, and cascading processes, of the program package. In an embodiment, the inbound processes define at least one inbound operation to read or modify data encapsulated in the program package. The inbound operation may include, but is not limited to, requirement analysis of the program package, development of the program package, and testing of the program package. In another embodiment, the outbound processes define at least one outbound operation to read or modify data encapsulated in the program package. The outbound operation may include, but is not limited to, maintaining and supporting the program package after delivering to the user.

The solution recommendation module (116) is configured to cooperate with the prediction module (114) and the diagnosis module (112) to receive the predicted future issues and the analyzed data respectively and further configured to recommend a first set of solutions for the current issues and the future issues based on the historical data and the solution recommendation rules. In an embodiment, the issues identified by the prediction module (114) and the diagnosis module (112) are either fixed on an ongoing basis if the issues are highly critical or are provided with a long term fix based on a prioritization. In one embodiment, the solution recommendation module (116) is configured to provide speedy fix or short-term fix to the critical incident issue, which helps in load distribution of the issues in the product.

In one embodiment, the self-service tools include, but are not limited to, self solutioning use cases, and self-healing mechanisms.

The trend recommendation module (118) is configured to cooperate with the program evaluator (110) and the trend repository (108) to receive the evaluated program data and the current trends, respectively, and further configured to recommend a second set of solutions based on the current trends. In an embodiment, the trend recommendation module (118) is further configured to identify and fixing the issues from the current trends, and then generates a short term fix or a long term fix for the issues in hand on the basis of the identified solutions and fixing issues. In one embodiment, the short term fix is provided for critical incident problems and change/release issues, and the long term fix is provided for the identified long term issues, such as loop holes in the program package, bugs, and the like. In an embodiment, the trend recommendation module (118) is configured to recommend solutions, using smart use cases, robotic process automation (RPA), partial automation, full automation, and self-service tools. In an embodiment, the robotic process automation (RPA), partial automation, or full automation implement solutions to fix issues without manual intervention. The self-service tools enable a user to resolve the issues themselves instead of reaching out to an operation team. The smart use cases provide auto-correction of the issues.

A pseudo-code depicting the functionality of the trend recommendation module (118), in accordance with an embodiment of the present disclosure, is as follows:
Provide an interface to a user, Interface_Agent ( )
Capture the information of logs, etc., when user logs in, or browses on the web;
Extracting stored information;
Identify data points causing issues/errors based on the highly critical problem, or recurring problems;
Parse and analyze the stored information and the identified data points;
Extract the data of the user and transaction details of the user;
If a field is unavailable, analyze further to find when the field was first entered into the system in the bundle of order;
Analyze and identify if the field availability is validated (adding to bundle) through Short-Term Fix Generation; and
Check for available options and intimate the user to use the alternate field;
Update the database (Table);
Generate a short term fix and/or long term fix;
In a case of the critical incident issues/errors and change/release issues/errors, a short term fix is provided;
In a case of the identified long term problems, a long term fix is provided.

Take for example, if a vehicle is implemented with the system 100, then the diagnosis module (112) monitors the operation of the vehicle and identifies the problems such as (i) difficulty in changing the gears, and (ii) improper operation of the air conditioning system simultaneously. The diagnosis module (112) analyzes these problems and the reasons behind it, and prioritizes the problem associated with difficulty in changing of the gear as it is critical in nature. The information related to difficulty in changing the gears and the extracted historic trends are analyzed by the trend recommendation engine 116, to provide either a short-term fix or a long term fix to the problem. One of the short-term fix could be automatically adjusting the amount of lubrication used in the gear box for efficient operation. One of the long-term fix could be updating the system (100) with the information about the optimum amount of lubrication required in the gear box for effective operation so that the problem related to the difficulty in changing gears could be eliminated or looked upon even before it occurs or is notified by the users. In this way, the customer or the user does not come to know of the issue and the operation of the vehicle becomes a smooth experience as the error is completely eliminated even before its occurrence.

Hence, the system (100) of the present disclosure alleviates the drawback of the conventional response development tool sub-system models in which only a reactive approach was used to encounter or solve ongoing issues of the system (100), together minimizes the operational cost, increases the customer.

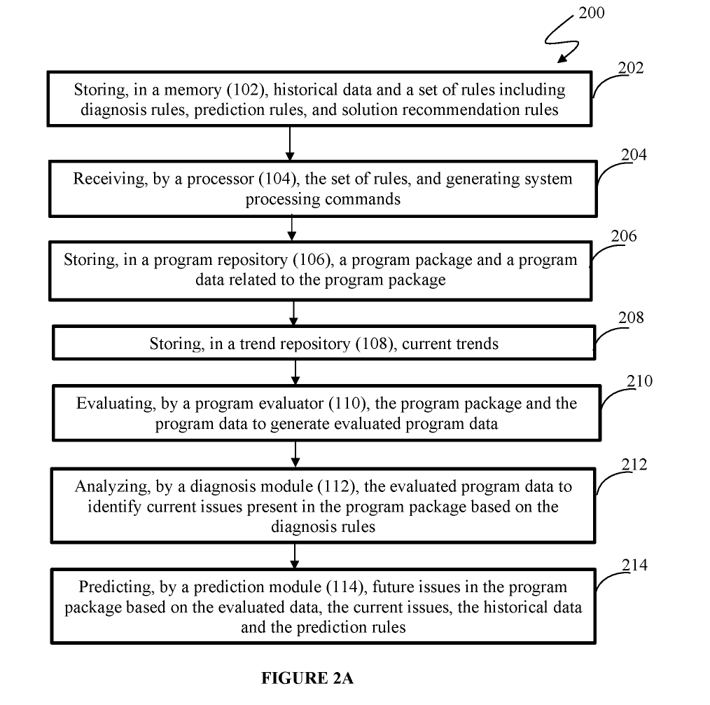

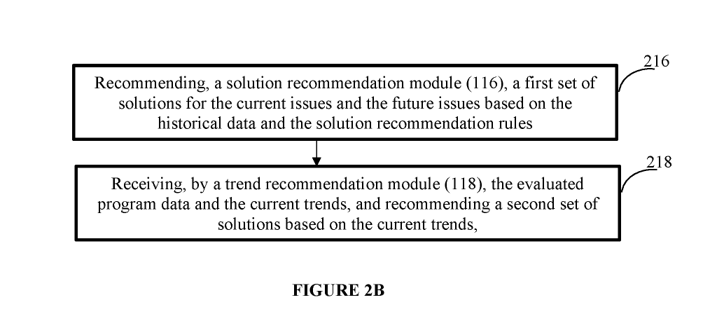

FIGS. 2A and 2B illustrates a flow diagram showing the steps performed by a method for providing an adaptive methodology framework, in accordance with an embodiment of the present disclosure. The method steps are as follows:

At block 202, storing historical data and a set of rules including diagnosis rules, prediction rules, and solution recommendation rules. In an embodiment, a memory 102 stores the historical data and the set of rules.

At block 204, receiving the set of rules and generating system processing commands. In an embodiment, a processor 104 receives the set of rules and generates the system processing commands.

At block 206, storing a program package and a program data related to the program package. In an embodiment, a program repository 106 stores a program package and a program data related to the program package. The program repository 106 includes a requirement module 106a which receives additional requirements from a user.

At block 208, storing current trends. In an embodiment, a trend repository 108 stores the current trends. The trend repository 108 includes an updater module (108a) which updates the trend repository (108).

At block 210, evaluating the program package and the program data to generate evaluated program data. In an embodiment, a program evaluator 110 evaluates the program package and the program data to generate evaluated program data.

At block 212, analyzing the evaluated program data to identify current issues present in the program package based on the diagnosis rules. In an embodiment, a diagnosis module 112 analyzes the evaluated program data to identify current issues present in the program package based on the diagnosis rules. The diagnosis module 112 includes a first analyzer 112a which analyzes the evaluated program data.

At block 214, predicting future issues in the program package based on the evaluated data, the current issues, the historical data and the prediction rules. In an embodiment, a prediction module 114 predicts future issues in the program package based on the evaluated data, the current issues, the historical data and the prediction rules. The prediction module 114 includes a second analyzer 114a which analyzes the evaluated data, the current issues, and the historical data.

At block 216, recommending a first set of solutions for the current issues and the future issues based on the historical data and the solution recommendation rules. In an embodiment, a solution recommendation module 116 recommends a first set of solutions for the current issues and the future issues based on the historical data and the solution recommendation rules.

At block 218, receiving the evaluated program data and the current trends, and recommending a second set of solutions based on the current trends. In an embodiment, a trend recommendation module 118 receives the evaluated program data and the current trends, and recommending a second set of solutions based on the current trends.

### Technical Advancements and Economical Significance

The present disclosure described herein above has several technical advantages including, but not limited to, the realization of an adaptive methodology framework system and method thereof, which:
performs in an optimal manner from cost and time perspective;
is capable of partially or completely automating the operational process, which reduces human effort;
is industry agnostic;
satisfies scalability and stability requirement of the conventional support systems;
recommends or executes solutions which are less vulnerable to human error;
improves predictability of occurrence of an issue; and
identifies the self-healing and self-solutioning use cases that can be implemented in an existing system as patches or supporting modules.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An adaptive methodology framework system comprising:
a memory configured to store historical data and a set of rules including diagnosis rules, prediction rules, and solution recommendation rules;
a processor configured to receive said set of rules from the memory, and further configured to generate system processing commands;
a program repository configured to store a program package and a program data related to said program package;
a trend repository configured to store current trends;
a program evaluator configured to evaluate said program package and said program data to generate evaluated program data;
a diagnosis module configured to analyze the evaluated program data to identify current issues present in said program package based on the diagnosis rules;
a prediction module configured to predict future issues in said program package based on the evaluated data, the current issues, the historical data and the prediction rules;
a solution recommendation module configured to recommend a first set of solutions for said current issues and said future issues based on said historical data and the solution recommendation rules; and
a trend recommendation module configured to cooperate with the program evaluator and the trend repository to receive the evaluated program data and the current trends, respectively, and further configured to recommend a second set of solutions based on the current trends.

2. The system as claimed in claim 1, wherein the diagnosis module includes a first analyzer configured to analyze the evaluated program data.

3. The system as claimed in claim 1, wherein the prediction module includes a second analyzer configured to analyze the evaluated data, the current issues, and the historical data.

4. The system as claimed in claim 1, wherein the program repository includes a requirement module configured to receive additional requirements from a user.

5. The system as claimed in claim 1, wherein the trend repository includes an updater module configured to update said trend repository.

6. The system as claimed in claim 1, wherein said trend recommendation module is configured to recommend solutions, using at least one technique selected from the group consisting of smart use cases, robotic process automation (RPA), partial automation, full automation, and self-service tools.

7. A method for providing an adaptive methodology framework comprising the following steps:
storing, in a memory, historical data and a set of rules including diagnosis rules, prediction rules, and solution recommendation rules;
receiving, by a processor, said set of rules, and generating system processing commands;
storing, in a program repository, a program package and a program data related to said program package;
storing, in a trend repository, current trends;
evaluating, by a program evaluator, said program package and said program data to generate evaluated program data;
analyzing, by a diagnosis module, the evaluated program data to identify current issues present in said program package based on the diagnosis rules;
predicting, by a prediction module, future issues in said program package based on the evaluated data, the current issues, the historical data and the prediction rules;
recommending, by a solution recommendation module, a first set of solutions for said current issues and said future issues based on said historical data and the solution recommendation rules; and
receiving, by a trend recommendation module, the evaluated program data and the current trends, and recommending a second set of solutions based on the current trends.
